(19) United States
(12) Patent Application Publication
(10) Pub. No.: US 2026/0261479 A1
(43) Pub. Date: Sep. 3, 2026

(54) SYSTEM AND METHOD FOR UPGRADATION OF NETWORK ELEMENTS

(71) Applicant: JIO PLATFORMS LIMITED, Ahmedabad (IN)

(72) Inventors: Aayush BHATNAGAR, Navi Mumbai, Maharashtra (IN); Vikash AGRAWAL, Navi Mumbai, Maharashtra (IN); Pramila KASAR, Nashik, Maharashtra (IN); Nabarun PAUL, Agartala, Tripura (IN); Faizan SHAIKH, Kalyan, Maharashtra (IN); Vedant SAHU, Raipur, Chhattisgarh (IN)

(73) Assignee: JIO PLATFORMS LIMITED, Ahmedabad (IN)

(21) Appl. No.: 18/879,972

(22) PCT Filed: Aug. 30, 2023
(86) PCT No.: PCT/IB2023/058569

§ 371 Date: Dec. 30, 2024

(30) Foreign Application Priority Data
Aug. 31, 2022 (IN) 202221049810

(51) Int. Cl. H04L 41/084; H04L 41/082; H04L 41/12; H04L 41/22

(52) U.S. Cl. CPC H04L 41/084; H04L 41/082; H04L 41/12; H04L 41/22

(57) ABSTRACT

Embodiments of a Converged Network Operations Platform (CN OPS) are disclosed that include a CN OPS server that comprises a processor coupled to a memory. In an embodiment, the processor causes the CN OPS to obtain data for node management and site topology management from a plurality of Network Functions (NFs) associated with a communication network via a CN OPS user interface (UI), provide binary management for the plurality of NFs by using a binary .zip file for adding binaries from zip file contents, provide support for script management of the plurality of NFs by using the binary .zip file for adding executable script files from the zip files contents, and provide configuration management for the plurality of NFs by one or more of: using a plurality of modification templates and replacing a plurality of configuration documents.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present invention relates to network operations, and specifically to a system and method for upgradation of network elements.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, a telecom operator ensures that all network functions work in tandem to provide reliable connectivity so as to create an unparalleled satisfactory customer experience. In addition, manual automation/upgradation or semi-automation of network parts may not be feasible, if Service Level Agreements (SLAs) are to be sustained faster.

There is therefore a need in the art to provide a systematic network upgradation and maintenance mechanism/system that enables the network to automatically and quickly adapt to changes based on customers' demands and requirements.

### OBJECTS OF THE PRESENT DISCLOSURE

It is an object of the present disclosure to provide a platform for automating upgradation of network elements (micro services).

It is an object of the present disclosure to provide a higher degree of automation and elasticity in network elements upgradation.

It is an object of the present disclosure to provide an improved resiliency and better customer experience.

It is an object of the present invention to provide seamless network services irrespective of changing network dynamics.

### SUMMARY OF INVENTION

Embodiments of a Converged Network Operations Platform (CN OPS) are disclosed. In an embodiment, CN OPS includes a CN OPS server that comprises a processor coupled to a memory that comprises one or more engines/modules that when executed by the processor causes the CN OPS to perform a set of steps. In an embodiment, the processor causes the CN OPS to obtain data for node management and site topology management from a plurality of Network Functions (NFs) associated with a communication network via a CN OPS user interface (UI) and provide binary management for the plurality of NFs by using a binary .zip file for adding binaries from zip file contents. The processor further causes the CN OPS server to provide support for script management of the plurality of NFs by using the binary .zip file for adding executable script files from the zip files contents and provide configuration management for the plurality of NFs by one or more of: using a plurality of modification templates and replacing a plurality of configuration documents.

In an embodiment, the processor further causes the CN OPS server to apply a Method of Procedure (MOP) template to an instance of network function. In an embodiment, the processor further causes the CN OPS server to receive the binary.zip file via the CN OPS user interface. In an embodiment, in order to apply the Method of Procedure (MOP) template, the processor further causes the CN OPS server to select the instance of network function (NF), select a site for the instance of NF, select a cluster for the instance of NF, select micro-services for the instance of NF, and apply or execute the MOP template based on the selected site, cluster, microservices for the instance of the NF.

In an embodiment, the processor further causes the CN OPS server to manage and capture details about each of a plurality of nodes in the communication network that are deployed over a plurality of sites and in a plurality of clusters. In an embodiment, the processor further causes the CN OPS server to coordinate and manage upgradation by building end to end upgradation process for a network function cluster by using a plurality of micro services, wherein the network functions cluster is executed subsequently based on the updates/upgradation. In an embodiment, the processor further causes the CN OPS server to automate a plurality of jobs/tasks that an admin user performs for managing the plurality of network functions.

In an embodiment, the processor further causes the CN OPS server to communicate with a database to store files associated with the plurality network functions and save changes that are required during an upgrade process of a plurality of network elements. In an embodiment, the processor further causes the CN OPS server to communicate with an Operations, Administration and Maintenance (OAM) engine/module to provide operation and management functionality for the plurality of network functions and to control a plurality of microservices.

Embodiments of a computer-implemented method for providing network management functions via a Converged Network Operations Platform (CN OPS) are disclosed. In an embodiment, the method includes obtaining, by a CN OPS server comprised in the CN OPS, data for node management and site topology management from a plurality of Network Functions (NFs) associated with a communication network via a CN OPS user interface (UI). The computer-implemented method further includes providing, by the CN OPS server, a binary management for the plurality of NFs by using a binary .zip file for adding binaries from zip file contents and providing, by the CN OPS server, support for script management of the plurality of NFs by using the binary .zip file for adding executable script files from the zip files contents. The computer-implemented method further includes providing, by the CN OPS server, configuration management for the plurality of NFs by one or more of: using a plurality of modification templates and replacing a plurality of configuration documents.

In an embodiment, the computer-implemented method further includes applying, by the CN OPS server, a Method of Procedure (MOP) template to an instance of network function. In an embodiment, the computer-implemented method further includes receiving, by the CN OPS server, the binary.zip file via the CN OPS user interface. In an embodiment, the computer-implemented method further includes: selecting, by the CN OPS server, the instance of network function (NF), selecting, by the CN OPS server, a site for the instance of NF, selecting, by the CN OPS server, a cluster for the instance of NF, selecting, by the CN OPS server, micro-services for the instance of NF, and applying or executing, by the CN OPS server, the MOP template based on the selected site, cluster, microservices respectively for the instance of the NF.

In an embodiment, the computer-implemented method further includes coordinating and managing upgradation, by the CN OPS server, by building end to end upgradation process for a network function cluster by using a plurality of micro services, wherein the network functions cluster is executed subsequently based on the updates/upgradation.

In an embodiment, the computer-implemented method further includes automating, by the CN OPS server, a plurality of jobs/tasks that an admin user performs for managing the plurality of network functions. In an embodiment, the computer-implemented method further includes communicating, by the CN OPS server, with a database to store files associated with the plurality network functions and save changes that are required during an upgrade process of a plurality of network elements. In an embodiment, the computer-implemented method further includes communicating, by the CN OPS server, with an Operations, Administration and Maintenance (OAM) engine/module to provide operation and management functionality for the plurality of network functions and to control a plurality of micro-services.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates a Converged Network Operations Platform (CN OPS), in accordance with an embodiment of the present disclosure.

FIG. 2 illustrates a high level architecture of the CN OPS platform, in accordance with an embodiment of the present disclosure.

FIG. 3 illustrates an exemplary network function upgrade process, in accordance with an embodiment of the present disclosure.

FIG. 4 illustrates an exemplary CN OPS call flow, in accordance with an embodiment of the present disclosure.

FIG. 5 illustrates a Method of Procedure (MOP) creation, in accordance with an embodiment of the present disclosure.

FIG. 6 illustrates a series of exemplary MOP template creation steps, in accordance with an embodiment of the present disclosure.

FIG. 7 illustrates an exemplary computer system in which or with which embodiments of the present invention can be utilized in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present invention relates to network operations, and specifically to a system and method for upgradation of network elements based on real time demand. The invention discloses an intelligent solution to upgrade the network functions in order to provide best customer experience. The disclosed invention may be integrated with Artificial Intelligence (AI), data native, and automation technologies based on technical advantages in the 5G core network and in depth understanding of Operation and Maintenance (O&M) services.

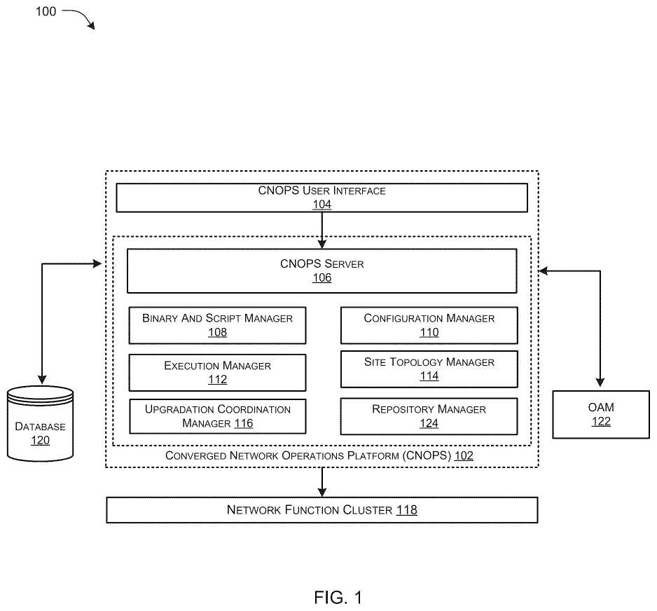

FIG. 1 illustrates a network architecture 100 of a Converged Network Operations Platform (CN OPS) 102, in accordance with an embodiment of the present disclosure. With respect to FIG. 1 is illustrated a CN OPS user interface 104 that is used to fetch information by the CN OPS 102 and pass on to a CN OPS server 106 comprised in the CN OPS 102. The CN OPS server 106 includes a binary and script manager 108, a configuration manager 110, an execution manager 112, a site topology manager 114, an upgradation coordination manager 116, and a repository manager 124. In an embodiment, the user interface 104 communicates with the CN OPS server 106 through Application Programming Interface (API) calls. A set of varied APIs may be defined and provided for use on the disclosed CN OPS platform 102.

In an embodiment, an administrator or an admin user communicates with the CN OPS platform 102 or CN OPS server 106 using the CN OPS user interface 104 that provides a graphical user interface to expose the features and functionalities of the platform. In an embodiment, the CN OPS 102 may receive external data from a database 120. In addition, the CN OPS 102 may receive data from Operations, Administration and Maintenance (OAM) component/module/engine 122. The data processed at the CN OPS 102 is sent as output to a network function cluster 118.

In an embodiment, CN OPS 102 can be implemented as a single computing device or a server or a cluster of servers. For example, the CN OPS 102 includes a CN OPS server 106 that may further comprise a processor coupled to a memory that comprises one or more engines/modules that when executed by the processor causes the CN OPS to perform a set of steps or functions as disclosed herein. For example, the processor causes the CN OPS 102 to obtain data for node management and site topology management from a plurality of Network Functions (NFs) associated with a communication network via a CN OPS user interface (UI) 104.

In an embodiment, the processor causes the CN OPS 102 or the CN OPS server 106 to provide binary management for the plurality of NFs by using a binary .zip file for adding binaries from zip file contents. The processor may further cause the CN OPS server 106 to provide support for script management of the plurality of NFs by using the binary .zip file for adding executable script files from the zip files contents and provide configuration management for the plurality of NFs by one or more of: using a plurality of modification templates and replacing a plurality of configuration documents.

In an embodiment, the processor may further cause the CN OPS server 106 to apply a Method of Procedure (MOP) template to an instance of network function. In an embodiment, the processor may further cause the CN OPS server 106 to receive the binary.zip file via the CN OPS user interface 104. In an embodiment, in order to apply the Method of Procedure (MOP) template, the processor further causes the CN OPS server 106 to select the instance of network function (NF), select a site for the instance of NF, select a cluster for the instance of NF, select micro-services for the instance of NF, and apply or execute the MOP template based on the selected site, cluster, microservices for the instance of the NF.

In an embodiment, the processor further causes the CN OPS server 106 to manage and capture details about each of a plurality of nodes in the communication network that are deployed over a plurality of sites and in a plurality of clusters. In an embodiment, the processor further causes the CN OPS server 106 to coordinate and manage upgradation by building end to end upgradation process for a network function cluster by using a plurality of micro services. The network functions cluster is executed subsequently based on the updates/upgradation. In an embodiment, the processor may further cause the CN OPS server 106 to automate a plurality of jobs/tasks that an admin user performs for managing the plurality of network functions.

In an embodiment, the processor may further cause the CN OPS server 106 to communicate with the database 120 to store files associated with the plurality network functions and save changes that are required during an upgrade process of a plurality of network elements. In an embodiment, the processor further causes the CN OPS server to communicate with an Operations, Administration and Maintenance (OAM) engine/module 122 to provide operation and management functionality for the plurality of network functions and to control a plurality of microservices. Although the above steps/functions are described as being performed by the CN OPS server 106, it may be appreciated that each of the steps/functions may be performed by one or more components/modules/engines comprised in the CN OPS server 106 that includes the binary and script manager 108, the configuration manager 110, the execution manager 112, the site topology manager 114, the upgradation coordination manager 116, and the repository manager 124.

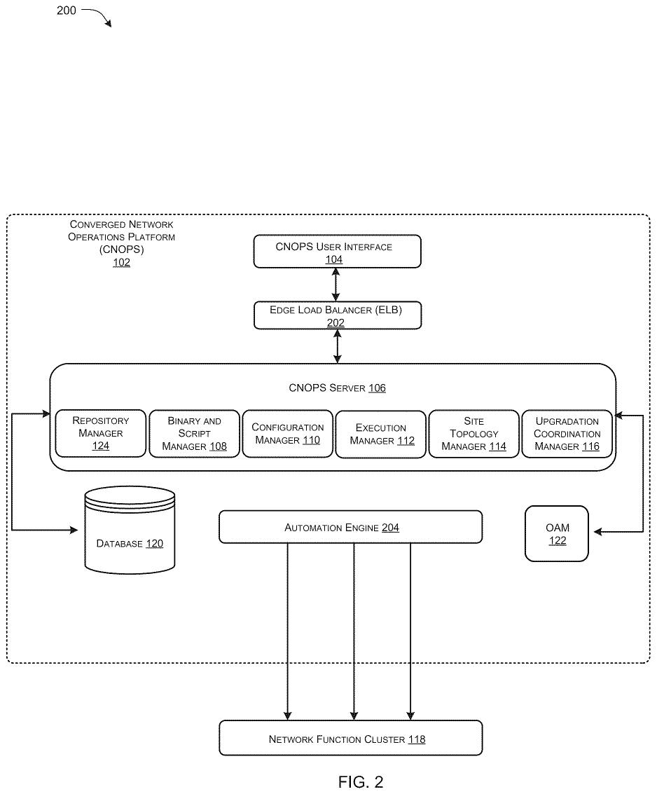

FIG. 2 illustrates a high level architecture 200 of the CN OPS 102, in accordance with an embodiment of the present disclosure. With respect to FIG. 2 is illustrated the CN OPS user interface 104. The interface 104 acts as a medium between an admin user and the CN OPS server 106. As described earlier, one of the essential and initial requirement of the user interface is to obtain data for node management and site topology management from the user in accordance with an embodiment of the disclosure.

In an embodiment, the CN OPS 102 includes an Edge load balancer (ELB) 202 that provides the load balancing services for communication between the CN OPS server 106 and a plurality of NFs. In an embodiment, the CN OPS server 106 is a prime entity of the CN OPS platform 102 and is configured to perform multiple steps and provide multiple functionalities as described herein. The CN OPS server 106 communicates with the database 120 to save changes required during network element upgrades. The CN OPS server 106 communicates with the OAM platform 122 and also controls over other micro services (not shown) of the OAM platform 122.

As shown in FIG. 2, the CN OPS server 106 includes the repository manager 124. In an embodiment, the repository manager 124 facilitates to upgrade entire setup. In an embodiment, the repository manager 124 facilitates to upload repository details to the CN OPS server 106.

Further, as shown in FIG. 2, the CN OPS server 106 includes the binary and script manager 108. In an embodiment, the binary and script manager 108 facilitates to provide NF's binary management by a using .zip file for adding binaries from zip file contents. The binary.zip file may be uploaded via the CN OPS user interface 104 in accordance with an embodiment. Further, the binary and script manager 108 also provides support for NF's script management by using the .zip file for adding executable script files from the zip files contents.

In an embodiment, the configuration manager 110 comprised in the CN OPS server 106 provides NF configuration management by using modifications templates or by replacement of whole configuration documents for the corresponding network function. In an embodiment, the configuration management functionality provided by the CN OPS server 106 is exposed by Restful APIs.

In an embodiment, the execution manager 112 applies a Method of Procedure (MOP) template to a network function instance. In an embodiment, the steps involved for application of such an MOP template include (i) selection of a NF, (ii) selection of NF site, (iii) selection of NF Cluster, (iv) selection of a plurality of micro-services, and (v) application or execution of the MOP template.

In an embodiment, the site topology manager 114 manages and captures details about each of the plurality of nodes in the communication network that are deployed over a plurality of sites and in a plurality of clusters.

In an embodiment, the upgradation coordination manager 116 helps in building end to end upgradation process. The CN OPS server 106 with the help of a plurality of micro services applies the upgrades on a network functions cluster (e.g., 118). Subsequent to such an upgradation, the network functions cluster are executed based on the last updates.

In an embodiment, the automation engine 204 automates the jobs/tasks that the user needs to perform. In an embodiment, ‘Ansible’ is used as the automation engine 204 to perform the upgradation tasks on remote servers through the playbook. This may be performed by using inventory and variables provided to the automation engine 204.

As described earlier, the database 120 is used to store files. Further, the OAM component/engine/module 122 is used to provide operation and management functionality.

In an embodiment, the network function clusters 118 correspond to the clusters on which 5G or 6G NFs are deployed.

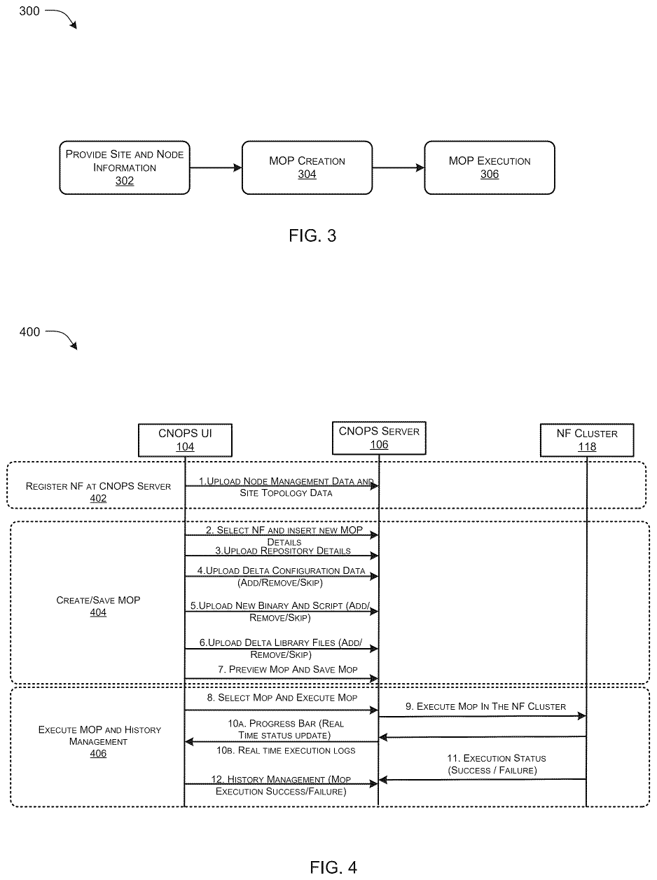

FIG. 3 illustrates an exemplary network function upgrade process 300, in accordance with an embodiment of the present disclosure. In an embodiment, an admin user can communicate through the graphical user interface (e.g., 104) using a three-step procedure for making any upgrades/changes in the communication network. With respect to FIG. 3, the first step 302 provides the site and node information that needs an upgrade. The second step 304 includes obtaining all the details Method of Procedure (MOP) creation. In an embodiment, the details include libraries, binaries and scripts, etc. The differentials are then consolidated and saved into a template (for example, yaml file). The final and third step 306 involves execution of the MOP template. The network function site, cluster and eventually the micro service are selected by the admin user where the MOP template is to be applied and executed.

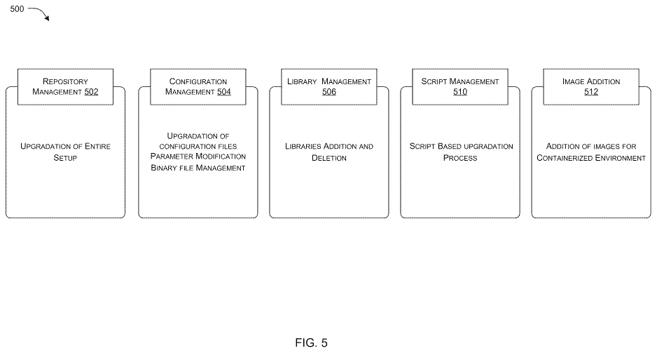

FIG. 4 illustrates an exemplary CN OPS call flow 400, in accordance with an embodiment of the present disclosure. With respect to FIG. 4, functions and services of the CN OPS 102 are presented. For ease of understanding, the call flow 400 has been described as signal flows or interaction messages between CN OPS UI 104, CN OPS server 106, and the Network Function cluster 118. In an embodiment, as part of the node management function, the CN OPS 102 holds various information about the nodes currently deployed i.e., micro services/processes names, path of libraries of each micro-services, path of configuration of each micro services and path of binary of each of the micro services. The node metadata contains the NF name, micro processes/services details, configuration/library/binary path, and containers image name. The node management function enables the admin user to perform a plurality of functions using the CN OPS 102. In an embodiment, the functions include, for example, node addition (which in CN OPS 102 is a two-step process), NF configuration (node configuration), site configuration, cluster configuration, update node configuration, update site configuration, update cluster configuration, and delete node.

Under site topology management functionality of the CN OPS 102, the CN OPS manages and captures details about each of the nodes that are deployed over multiple sites and in multiple clusters. The site topology management function further includes details like username, password and micro-services running on each host of each of the cluster. In addition, site topology information is maintained by CN OPS 102 which mainly includes site names, site type, super-core/circle name, cluster names and cluster details such as server IP, username, hostname and password for the server and deployed micro-services.

With respect to FIG. 4, the call flow 400 includes 3 broad phases: registering NF at CN OPS server 402, creation and saving of MOP 404, and execution of MOP and history management 406.

For registering NF at CN OPS server 106, at step 1, a user via the CN OPS UI 104 uploads node management data and site topology data to the CN OPS server 106.

To create and save Method of Procedure (MOP), the user via the CN OPS UI 104 selects an instance of NF and inserts new MOP details that is sent to the CN OPS server 106 at step 2. This is followed by uploading repository details at step 3, uploading delta configuration data at step 4, uploading new binary and script at step 5, uploading delta library files to the CN OPS server 106 at step 6 via the CN OPS UI 104. In addition, the MOP is previewed and saved at the CN OPS server 106 at step 7.

To execute MOP and for history management, the user via the CN OPS UI 104 selects MOP and executes MOP at the CN OPS server 106 at step 8, which in turn executes MOP in the NF cluster 118 at step 9 as shown. The NF cluster 118, at step 10a, updates progress bar with real time status at the CN OPS server 106, and at step 10b, provides real-time execution logs to the CN OPS server 106, that shares the updates with the user via the CN OPS UI 104. The NF cluster 118, at step 11, shares an execution status related to success/failure with the CN OPS server 106. Finally, the user via the CN OPS UI 104 shares history management information (MOP execution success/failure) with the CN OPS server 106 at step 12 as shown.

In an embodiment, the user via the CN OPS UI 104 may see their real-time progress of execution through checkpoints in the process of execution. For example, a progress bar may show the status of each checkpoint, and on successful completion move on to the next checkpoint. However, on the contrary, if there is an unsuccessful or negative scenario, an error code may be displayed along with an error reason.

In an embodiment, the user via the CN OPS UI 104 may see the real-time logs of their respective application server remotely to ensure that the automated process of upgradation is executing in an expected manner. In some embodiments, the user may provide inputs via the CN OPS UI 104 remotely to their respective application server.

FIG. 5 illustrates a flow diagram 500 for Method of Procedure (MOP) creation and management, in accordance with an embodiment of the present disclosure. With respect to FIG. 5, the MOP creation by the CN OPS server 106 involves creating a Method of Procedure for upgradation of the NF with steps involving operations to change configuration, binary, library and script files on a remote server. In an embodiment, the MOP can be created for micro-services of the NF. In an embodiment, the MOP creation may be for either a containerized environment or a non-containerized environment.

In an embodiment, the MOP creation includes following set of information that a user is required to specify to indicate the nature of changes to applicable files. As described earlier, the admin user may provide all such information via the CN OPS UI 104 to the CN OPS server 106. In an embodiment, the MOP creation includes following information that the admin user may provide: (i) changes in entire setup and changes in configuration to upgrade (add or remove) any configuration files of any types (Excel, JSON, SV etc.), (ii) changes in library if an existing library has to removed, replaced etc. This action is recorded if a new library has to be added. Also, name and destination path is recorded, (iii) change in binary. The details and the destination path where the binaries need to be copied, (iv) script execution: For the above mentioned steps, if the application needs to execute any scripts then this is taken as an input and associated with specific binary or library, (v) sequence of execution: The sequence of execution is taken as an input for all processes in the topology, and (vi) MOP Template final creation process: The template contains all the actions performed as mentioned above. The CN OPS 102 may execute these instructions in the execution phase as explained above. Accordingly, the MOP creation may include repository management 502, configuration management 504, library management 506, script management 508, and the image addition 510. The repository management 502 may include upgradation of entire setup of the CN OPS 102. The configuration management 504 may include upgradation of configuration files, parameter modification and binary file management. The library management 506 may include addition or deletion of libraries. The script management 508 may include script based upgradation process. The image addition 510 may include addition of images for containerized environment.

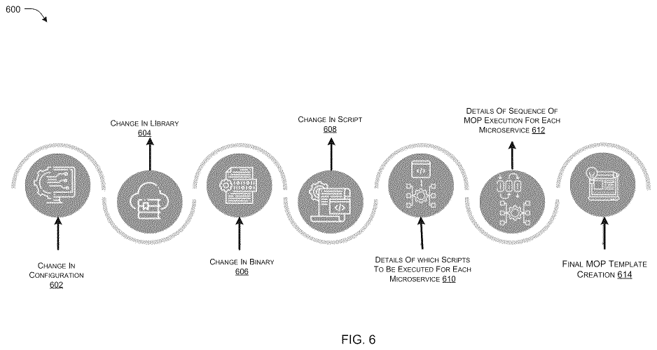

FIG. 6 illustrates a flow diagram 600 for creation of an exemplary MOP template, in accordance with an embodiment of the present disclosure. With respect to FIG. 6 is illustrated a series of steps that may be executed for implementing change management functions in CN OPS 102. The overall procedure includes change in configuration at step 602, change in library at step 604 as part of library management procedure that lets the user add/modify/delete libraries, and change in binary at step 606 for adding/modifying/deleting binaries files on remote servers. In an embodiment, the user may upload complete zip folders with complete binaries set to replace the previous one or can append to the existing one. Similarly, new library files can be added and deleted.

The procedure further includes change in script at step 608 as part of script management procedures that lets the user add/modify/delete scripts on a customized path. In an embodiment, multiple scripts may be provided as an input by the users with specified binaries and libraries for execution. At step 610, details of which scripts to be executed for each microservice is provided by the user.

In an embodiment, with respect to image additions procedures-if the node is running in a containerized environment, the user mentions the image name for the processes of the micro-services for successful upgradation of the micro-services for the node.

At step 612, the user specifies the details of sequence of MOP execution for each microservice. In an embodiment, the MOP execution applies a MOP template to the network function instance. In an embodiment, the steps for execution of MOP template include (i) Selection of the NF instance, (ii) NF Site selection, (iii) NF Cluster selection, (iv) Micro-service selection, and (v) Apply/Execute Template. In an embodiment, the execution may be carried out on multiple clusters and multiple micro-services with order of execution according to micro-services selection sequence on the CN OPS user interface 104. Furthermore, disclosed system may be capable of maintaining change history and presenting it to user via the CN OPS interface 104. The change history may be stored in the memory associated with the CN OPS server 106 or in the database 120. Alternatively, the change history may be stored in an encrypted form with security protocols over cloud network.

At step 614, the procedure involves final MOP template creation based on the steps 602-612. Once the MOP template is created, the CN OPS server 106 may execute the MOP template as per the details provided during the MOP template creation procedure described above.

In another embodiment, Network Management System (NMS) components are designed as individual micro services so that each of the services are individually scalable and maintainable.

Cloud Native: The micro services may be deployed on Virtual Machines (VMs), docker containers, and various cloud platforms.

The disclosed CN OPS 102 is a core network operations platform which automates a process of upgrading various network elements. With a view to provide best customer experience, the disclosed CN OPS is an intelligent solution to upgrade network functions. It is deeply integrated with AI, data native, and automation technologies using the automation engine 204 based on technical advantages in the 5G core network and in depth understanding of O&M services. The disclosed platform will drastically cut down time taken for upgrades in production.

The disclosed invention drastically cuts down the time taken for upgrades in production. Furthermore, based on the business needs or customer requirements, the network can dynamically and flexibly adjust the network configuration parameters. Henceforth, in this new way of network function, upgradation not only meets the demand for change in customer needs, but also does it cost effectively, as it also reduces the manual intervention, the percentage of errors can also be decreased during the process. Additionally, the disclosed solution may be deployed on variety of hardware including RAC based or chassis based servers.

Embodiments of a computer-implemented method for providing network management functions via a Converged Network Operations Platform (CN OPS) are disclosed. In an embodiment, the method includes obtaining, by a CN OPS server comprised in the CN OPS, data for node management and site topology management from a plurality of Network Functions (NFs) associated with a communication network via a CN OPS user interface (UI). The computer-implemented method further includes providing, by the CN OPS server, a binary management for the plurality of NFs by using a binary .zip file for adding binaries from zip file contents and providing, by the CN OPS server, support for script management of the plurality of NFs by using the binary .zip file for adding executable script files from the zip files contents. The computer-implemented method further includes providing, by the CN OPS server, configuration management for the plurality of NFs by one or more of: using a plurality of modification templates and replacing a plurality of configuration documents.

In an embodiment, the computer-implemented method further includes applying, by the CN OPS server, a Method of Procedure (MOP) template to an instance of network function. In an embodiment, the computer-implemented method further includes receiving, by the CN OPS server, the binary.zip file via the CN OPS user interface. In an embodiment, the computer-implemented method further includes: selecting, by the CN OPS server, the instance of network function (NF), selecting, by the CN OPS server, a site for the instance of NF, selecting, by the CN OPS server, a cluster for the instance of NF, selecting, by the CN OPS server, micro-services for the instance of NF, and applying or executing, by the CN OPS server, the MOP template based on the selected site, cluster, microservices respectively for the instance of the NF.

In an embodiment, the computer-implemented method further includes coordinating and managing upgradation, by the CN OPS server, by building end to end upgradation process for a network function cluster by using a plurality of micro services, wherein the network functions cluster is executed subsequently based on the updates/upgradation.

In an embodiment, the computer-implemented method further includes automating, by the CN OPS server, a plurality of jobs/tasks that an admin user performs for managing the plurality of network functions. In an embodiment, the computer-implemented method further includes communicating, by the CN OPS server, with a database to store files associated with the plurality network functions and save changes that are required during an upgrade process of a plurality of network elements. In an embodiment, the computer-implemented method further includes communicating, by the CN OPS server, with an Operations, Administration and Maintenance (OAM) engine/module to provide operation and management functionality for the plurality of network functions and to control a plurality of microservices.

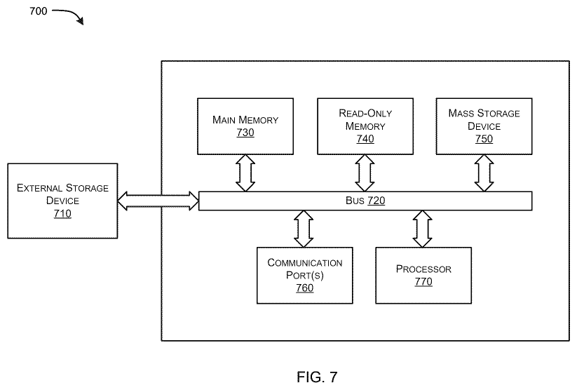

FIG. 7 illustrates an exemplary computer system 700 in which or with which embodiments of the present invention can be utilized in accordance with embodiments of the present disclosure. As shown in FIG. 7, computer system 700 can include an external storage device 710, a bus 720, a main memory 730, a read only memory 740, a mass storage device 750, communication port 760, and a processor 770. A person skilled in the art will appreciate that the computer system may include more than one processor and communication ports. Processor 770 may include various modules associated with embodiments of the present invention. Communication port (780 can be any of an RS-232 port for use with a modem based dialup connection, a 10/100 Ethernet port, a Gigabit or 10 Gigabit port using copper or fiber, a serial port, a parallel port, or other existing or future ports. Communication port 780 may be chosen depending on a network, such a Local Area Network (LAN), Wide Area Network (WAN), or any network to which computer system connects. Memory 730 can be Random Access Memory (RAM), or any other dynamic storage device commonly known in the art. Read-only memory 740 can be any static storage device(s) e.g., but not limited to, a Programmable Read Only Memory (PROM) chips for storing static information e.g., start-up or BIOS instructions for processor 770. Mass storage device 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks (e.g., SATA arrays).

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, joystick and a cursor control device, may also be coupled to bus 720 to support direct operator interaction with a computer system. Other operator and administrative interfaces can be provided through network connections connected through communication port 760. Components described above are meant only to exemplify various possibilities. In no way should the aforementioned exemplary computer system limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure facilitates to shift automation in upgrading the network elements to improve productivity; achieve promised levels of efficiency and technology service support for the users.

The present disclosure facilitates to provide in service upgradation.

The present disclosure facilitates to provide a high degree of automation and elasticity using AI algorithms for network service management using microservices.

The present disclosure facilitates to provide automated software upgrades to network components.

The present disclosure facilitates to provide OPEX improvements through reduced manual labour.

The present disclosure facilitates to improve resiliency and provide better customer experience.

The present disclosure facilitates to provide reliable continuity of services.

The present disclosure facilitates to provide flexible performance of the platform.

The present disclosure facilitates to provide CAPEX benefits for providing higher utilization levels of assets, aggregation gains and simplified hardware inventories.

We claim:

1. A Converged Network Operations Platform (CN OPS), comprising:
a CN OPS server comprising a processor coupled to a memory that comprises one or more engines/modules that when executed by the processor causes the CN OPS to:
obtain data for node management and site topology management from a plurality of Network Functions (NFs) associated with a communication network via a CN OPS user interface;
provide binary management for the plurality of NFs by using a binary .zip file for adding binaries from zip file contents;
provide support for script management of the plurality of NFs by using the binary .zip file for adding executable script files from the zip files contents; and
provide configuration management for the plurality of NFs by one or more of: using a plurality of modification templates and replacing a plurality of configuration documents.

2. The CN OPS as claimed in claim 1, wherein the processor is configured to apply a Method of Procedure (MOP) template to an instance of NF.

3. The CN OPS as claimed in claim 1, wherein the processor is configured to receive the binary .zip file via the CN OPS user interface.

4. The CN OPS as claimed in claim 2, wherein, in order to apply the MOP template, the processor is configured to:
select the instance of NF;
select a site for the instance of NF;
select a cluster for the instance of NF;
select micro-services for the instance of NF; and
apply or execute the MOP template based on the selected site, cluster, and micro-services for the instance of NF.

5. The CN OPS as claimed in claim 1, wherein the processor is configured to manage and capture details about each of a plurality of nodes in the communication network that are deployed over a plurality of sites and in a plurality of clusters, and wherein the processor is configured to provide repository management for the plurality of NFs.

6. The CN OPS as claimed in claim 1, wherein the processor is configured to coordinate and manage upgradation by building end to end upgradation process for a network function cluster by using a plurality of micro services, wherein the network functions cluster is executed subsequently based on the updates/upgradation.

7. The CN OPS as claimed in claim 1, wherein the processor is configured to automate a plurality of jobs/tasks that an admin user performs for managing the plurality of network functions.

8. The CN OPS as claimed in claim 1, wherein the processor is configured to communicate with a database to store files associated with the plurality network functions and save changes that are required during an upgrade process of a plurality of network elements.

9. The CN OPS as claimed in claim 1, wherein the processor is configured to communicate with an Operations, Administration and Maintenance (OAM) engine/module to provide operation and management functionality for the plurality of network functions and to control a plurality of microservices.

10. A computer-implemented method for providing network management functions via a Converged Network Operations Platform (CN OPS), the method comprising:
obtaining, by a CN OPS server comprised in the CN OPS, data for node management and site topology management from a plurality of Network Functions (NFs) associated with a communication network via a CN OPS user interface (UI);
providing, by the CN OPS server, a binary management for the plurality of NFs by using a binary .zip file for adding binaries from zip file contents;
providing, by the CN OPS server, support for script management of the plurality of NFs by using the binary .zip file for adding executable script files from the zip files contents; and
providing, by the CN OPS server, configuration management for the plurality of NFs by one or more of: using a plurality of modification templates and replacing a plurality of configuration documents.

11. The computer-implemented method as claimed in claim 10, comprising applying, by the CN OPS server, a Method of Procedure (MOP) template to an instance of network function.

12. The computer-implemented method as claimed in claim 10, comprising receiving, by the CN OPS server, the binary.zip file via the CN OPS user interface.

13. The computer-implemented method as claimed in claim 11, comprising selecting, by the CN OPS server, the instance of network function (NF);
selecting, by the CN OPS server, a site for the instance of NF;
selecting, by the CN OPS server, a cluster for the instance of NF;
selecting, by the CN OPS server, micro-services for the instance of NF; and
applying or executing, by the CN OPS server, the MOP template based on the selected site, cluster, and micro-services respectively for the instance of the NF.

14. The computer-implemented method as claimed in claim 11, comprising coordinating and managing upgradation, by the CN OPS server, by building end to end upgradation process for a network function cluster by using a plurality of micro services, wherein the network functions cluster is executed subsequently based on the updates/upgradation.

15. The computer-implemented method as claimed in claim 11, comprising automating, by the CN OPS server, a plurality of jobs/tasks that an admin user performs for managing the plurality of network functions.

16. The computer-implemented method as claimed in claim 11, comprising:
communicating, by the CN OPS server, with a database to store files associated with the plurality network functions and save changes that are required during an upgrade process of a plurality of network elements; and
communicating, by the CN OPS server, with an Operations, Administration and Maintenance (OAM) engine/module to provide operation and management functionality for the plurality of network functions and to control a plurality of microservices.

17. A non-transitory computer-readable medium comprising processor-executable instructions causing a processor to perform operations comprising:
obtaining data for node management and site topology management from a plurality of Network Functions (NFs) associated with a communication network via a Converged Network Operations Platform (CN OPS) user interface (UI);
providing a binary management for the plurality of NFs by using a binary .zip file for adding binaries from zip file contents;
providing support for script management of the plurality of NFs by using the binary .zip file for adding executable script files from the zip files contents; and
providing configuration management for the plurality of NFs by one or more of: using a plurality of modification templates and replacing a plurality of configuration documents.
